(19) United States
(12) Patent Application Publication
(10) Pub. No.: US 2026/0174537 A1
(43) Pub. Date: Jun. 25, 2026

(54) FLUID PUMPING ASSEMBLY AND ORAL CARE DEVICE FOR ORAL CLEANING

(71) Applicant: Shenzhen Soocas Technology Co., Ltd., Shenzhen (CN)

(72) Inventor: Sanlian Qin, Shenzhen (CN)

(73) Assignee: Shenzhen Soocas Technology Co., Ltd., Shenzhen (CN)

(21) Appl. No.: 19/428,112

(22) Filed: Dec. 20, 2025

Related U.S. Application Data
(63) Continuation of application No. PCT/CN2025/114234, filed on Aug. 12, 2025.

(30) Foreign Application Priority Data
Dec. 25, 2024 (CN) 2024119562235

(51) Int. Cl. A61C 17/024

(52) U.S. Cl. CPC A61C 17/024

(57) ABSTRACT

The present disclosure discloses a fluid pumping assembly for oral cleaning and an oral care device. The fluid pumping assembly at least includes a housing component, an execution unit, a transmission unit, and a drive unit. The housing component has an execution cavity, a transmission cavity, a drive cavity, and a liquid inlet and a liquid outlet communicating with the execution cavity. The transmission cavity is isolated and sealed from an exterior of the housing component, and the transmission cavity is isolated and sealed from the drive cavity. The execution unit is arranged inside the execution cavity, the transmission unit is arranged inside the transmission cavity, and part of the transmission unit extends into the execution cavity and connects to the execution unit.

### CROSSREFERENCE TO RELATED APPLICATION

This application is a continuation of International Application No. PCT/CN2025/114234, filed on August 12, 2025, which claims priority to Chinese Patent Application No. 2024119562235 titled "FLUID PUMPING ASSEMBLY AND ORAL CARE DEVICE FOR ORAL CLEANING" and filed to the State Patent Intellectual Property Office on December 25, 2024, the entire contents of which are incorporated herein by reference.

### TECHNICAL FIELD

The present disclosure relates to the field of oral care, and more particularly, to a fluid pumping assembly for oral cleaning and an oral care device.

### BACKGROUND

Oral care devices with oral flushing functions are typically equipped with pump bodies, and extract liquids from water tanks by means of the pump bodies and output water flow impact to users’ oral cavities for oral cleaning.

However, water vapor may leak out of the pump bodies during use, which may increase air humidity and even lead to liquid leakage. These situations may cause corrosion and damage to electronic components such as batteries and circuit boards inside the oral care devices.

### SUMMARY

An objective of the present disclosure is to provide a fluid pumping assembly for oral cleaning and an oral care device.

To achieve the above objective, in one aspect, the present disclosure provides a fluid pumping assembly for oral cleaning, which at least includes a housing component, an execution unit, a transmission unit, and a drive unit. The housing component has an execution cavity, a transmission cavity, a drive cavity, and a liquid inlet and a liquid outlet communicating with the execution cavity. The transmission cavity is isolated and sealed from an exterior of the housing component, and the transmission cavity is isolated and sealed from the drive cavity. The execution unit is arranged inside the execution cavity, the transmission unit is arranged inside the transmission cavity, and part of the transmission unit extends into the execution cavity and connects to the execution unit. The drive unit is arranged inside the drive cavity, where an output end of the drive unit extends into the transmission cavity and connects to the transmission unit. The drive unit drives the execution unit to move in the execution cavity by means of the transmission unit, to pump a liquid into the execution cavity through the liquid inlet and provide water flow impact through the liquid outlet.

Optionally, the housing component includes a first housing piece, a second housing piece, and a pump body, where the first housing piece and the second housing piece are coupled to each other, and jointly surround to form the transmission cavity and the drive cavity. The pump body is connected to one end of an entirety formed by splicing the first housing piece and the second housing piece, and the execution cavity is positioned inside the pump body. The liquid inlet and the liquid outlet are provided on the pump body.

Optionally, a first sealing member is provided on an engagement surface of the first housing piece and/or the second housing piece, where the first sealing member is arranged at least around the transmission cavity; and/or the first housing piece or the second housing piece is provided with a first clearance hole, where an output end of the drive unit extends into the transmission cavity through the first clearance hole, and a second sealing member is filled between the output end of the drive unit and the first clearance hole.

Optionally, a third sealing member is provided on the engagement surface of the first housing piece and/or the second housing piece, and the third sealing member is arranged around the drive cavity.

Optionally, the first sealing member and the third sealing member are integrally formed.

Optionally, one of the first housing piece and the second housing piece is integrally formed with the first sealing member by means of overmolding, and the other one of the first housing piece and the second housing piece is in an interference fit with the first sealing member.

Optionally, the first housing piece or the second housing piece is provided with a wire harness connection hole communicating with the drive cavity, and the wire harness connection hole is filled with a sealant.

Optionally, the first clearance hole and the wire harness connection hole are both provided on the first housing piece.

Optionally, the execution unit includes a cylinder liner, a piston, and a fourth sealing member. The cylinder liner is inserted into the execution cavity and extends a predetermined distance from the execution cavity towards a direction of the transmission unit. The piston is slidably connected to an interior the cylinder liner, the piston is connected to a piston sealing member, and a fitted seal is formed between the piston sealing member and an inner wall surface of the cylinder liner. The fourth sealing member is sleeved onto an outer wall surface of the cylinder liner and is positioned outside the execution cavity. A fitted seal is formed between the fourth sealing member and an inner wall surface of the first housing piece and of the second housing piece.

Optionally, the transmission unit includes a first gear, an end face eccentric gear, and a connecting rod. The first gear and the end face eccentric gear are arranged inside the transmission cavity, and the first gear is connected to the output end of the drive unit and is meshed with a gear portion of the end face eccentric gear. An eccentric portion of the end face eccentric gear is connected to one end of the connecting rod, and the other end of the connecting rod is connected to the execution unit. The first gear, the eccentric portion of the end face eccentric gear, and the connecting rod are positioned on a same side of the gear portion of the end face eccentric gear.

Optionally, the drive unit, the transmission unit, and the execution unit (200) are arranged along an axis line of the output end of the drive unit.

To achieve the above objective, another aspect of the present disclosure also provides an oral care device, which at least includes a grip housing and the fluid pumping assembly (1000) as mentioned above, where the grip housing has an outer wall and an accommodation chamber enclosed by the outer wall, and the accommodation chamber is configured to accommodate an electronic device and the fluid pumping assembly.

Optionally, the oral care device also includes a brush head and a motor, where the motor has a power output shaft. The motor drives the brush head to perform a cleaning motion by means of the power output shaft, and the power output shaft is a hollow shaft. The liquid outlet communicates with a transfer channel inside the brush head by means of the power output shaft.

Optionally, the grip housing has a main extension line, and the axis line of the output end of the drive unit is roughly parallel to the main extension line. The electronic device and the fluid pumping assembly are arranged along a direction perpendicular to the main extension line.

### BRIEF DESCRIPTION OF THE DRAWINGS

To describe the technical solutions in the embodiments of the present disclosure more clearly, the accompanying drawings required for describing the embodiments will be briefly introduced below. Apparently, the accompanying drawings in the following description are merely some embodiments of the present disclosure. To those of ordinary skills in the art, other accompanying drawings may also be derived from these accompanying drawings without creative efforts.

FIG. 1 is a half-sectional schematic view of a fluid pumping assembly according to an embodiment of the present disclosure;

FIG. 2 is a schematic three-dimensional diagram of a fluid pumping assembly according to an embodiment of the present disclosure;

FIG. 3 is a schematic exploded view of a fluid pumping assembly according to an embodiment of the present disclosure;

FIG. 4 is a schematic exploded view of a partial structure of a fluid pumping assembly according to an embodiment of the present disclosure;

FIG. 5 is a schematic three-dimensional diagram of a first housing piece according to an embodiment of the present disclosure;

FIG. 6 is a schematic exploded view of another partial structure of the fluid pumping assembly according to an embodiment of the present disclosure; and

FIG. 7 is a half-sectional schematic view of an oral care device according to an embodiment of the present disclosure.

Reference numerals in the accompanying drawings:

fluid pumping assembly 1000; grip housing 2000; accommodation chamber 2100; electronic device 2200;

housing component 100; execution cavity 110; liquid inlet 111; liquid outlet 112; transmission cavity 120; drive cavity 130; first housing piece 140; first clearance hole 141; wiring harness connection hole 142; second clearance hole 143; second housing piece 150; pump body 160; first sealing member 170; second sealing member 180; third sealing member 190;

execution unit 200; cylinder liner 210; piston 220; piston sealing member 221; fourth sealing member 230;

transmission unit 300; first gear 310; end face eccentric gear 320; connecting rod 330;

drive unit 400; and

main extension line a.

### DETAILED DESCRIPTION

At present, an oral care device on the market mainly adopts three design methods to achieve an oral flushing function. The first design is a design of combination of an oral irrigator with a liquid supply base station, where the liquid supply base station is internally provided with a pump body responsible for delivering a water flow to the oral irrigator to generate water flow impact. In the second design, the oral irrigator is integrated with the pump body, allowing the device to separately provide the water flow impact without the need for the additional liquid supply base station. In the third design, an integrated flushing machine not only integrates the flushing function, but also has a tooth brushing function. The integrated flushing machine is also integrated with the pump body to provide the required water flow impact. These design methods each have their own characteristics, can meet needs and usage scenarios of different users, but require the use of the pump body to provide the water flow impact.

However, commonly used water pumps such as a piston pump or diaphragm pump mainly extract a liquid by means of stroke and squeeze them into output pipelines, and leakage of water vapor may be caused during this process. Taking the piston pump as an example, in-depth research in the present disclosure has found that there is a cylinder liner inside the pump body, and the piston reciprocates inside the cylinder liner to suck in and discharge the liquid. During this process, the liquid may adhere to an inner wall of the cylinder liner, evaporate and form water vapor. The water vapor enters a transmission cavity, and then diffuses from the transmission cavity to a motor and outward, causing damage to the motor, and causing corrosion and damage to electronic components such as batteries and circuit boards in the oral care device. Moreover, with the long-term operation of the piston, a sealing ring between the piston and the cylinder liner may also be damaged or deformed, leading to leakage of the liquid , causing damage to the motor , and causing corrosion and damage to the electronic components such as the batteries and the circuit boards in the oral care device.

In the present disclosure, it is attempted to install two sealing rings on the piston to improve the sealing performance between the piston and the inner wall of the cylinder liner by increasing the number of the sealing rings, thereby avoiding leakage of water. But this solution also increases a friction between the piston and the cylinder liner, requires greater power to drive the piston, and still cannot prevent the liquid from adhering to the inner wall of the cylinder liner and cannot avoid evaporation and leakage.

In the present disclosure, it is also attempted to arrange an accordion folded sealing sleeve between an outer wall surface of the cylinder liner or an outer wall surface of a pump housing and a connecting rod that drives the piston to move, such that the sealing sleeve is used to isolate the liquid adhering to the inner wall of the cylinder liner from the outside, thereby preventing the liquid adhering to the inner wall of the cylinder liner from evaporating and diffusing outward. Although this solution can prevent leakage of the liquid and moisture, it is prone to causing damage and aging because the sealing sleeve need to follow the movement of the connecting rod, resulting in a shorter service life. Moreover, after the damage and aging, the leakage may still occur and thus cause damage to the electronic components.

Therefore, in the present disclosure, the transmission cavity is formed ultimately through a housing component of a fluid pumping assembly, and the transmission cavity is isolated and sealed from the exterior of the housing component. The sealed transmission cavity is used to confine the water vapor formed by the evaporation of the liquid adhering to the inner wall of the cylinder liner within the transmission cavity, thereby preventing the leakage of the water vapor from causing damage to the electronic components inside the oral care device, and prolonging the service life. Moreover, the sealed transmission cavity is formed by the housing component, it is less prone to fatigue damage because the housing component does not need to follow the movement of the transmission unit, thus ensuring the sealing life and the sealing effect.

In addition, in the present disclosure, the housing component is further utilized to form a drive cavity for accommodating the drive unit, and the drive cavity is isolated and sealed from the transmission cavity. In this way, the water vapor leaked into the transmission cavity may be prevented from further diffusing to the drive cavity and causing damage to the drive unit, thereby ensuring the service life of the drive unit. Furthermore, in the present disclosure, the drive cavity is also sealed from the exterior of the housing component. In this way, even if the water vapor in the transmission cavity accidentally leaks into the drive cavity, the water vapor is still confined to an interior of the housing component through a sealing structure of the drive cavity, such that a fault is prevented from further diffusing to the exterior of the housing component, thus narrowing a fault coverage.

To make the objectives, technical solutions, and advantages of the embodiments of the present disclosure clearer, the technical solutions in the embodiments of the present disclosure will be described clearly and completely below, in conjunction with the accompanying drawings in the embodiments of the present disclosure. Apparently, the described embodiments are some but not all of the embodiments of the present disclosure.

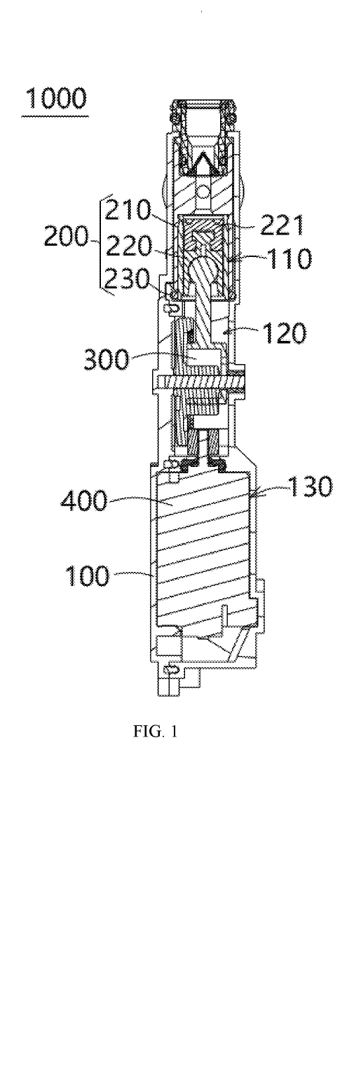

As shown in FIG. 1, in an implementable embodiment, the present disclosure provides a fluid pumping assembly 1000, which may be used in a device related to oral cleaning to provide water flow impact for the oral cleaning. The fluid pumping assembly 1000 may also be used in other devices that require water flow drive, and is not specifically limited here.

In this embodiment, the fluid pumping assembly 1000 may include a housing component 100, where the housing component 100 serves as a main component of the fluid pumping assembly 1000 and may be used to support and protect other components in the fluid pumping assembly 1000. The housing component 100 may have an execution cavity 110, a transmission cavity 120, a drive cavity 130, a liquid inlet 111, and a liquid outlet 112. The liquid inlet 111 and the liquid outlet 112 communicate with the execution cavity 110. The transmission cavity 120 is isolated and sealed from the exterior of the housing component 100, and the transmission cavity 120 is isolated and sealed from the drive cavity 130.

The fluid pumping assembly 1000 may also include an execution unit 200, a transmission unit 300, and a drive unit 400, where the execution unit 200 is arranged inside the execution cavity 110, and the execution unit 200 pumps in and discharges a water flow by performing a motion in the execution cavity 110. The transmission unit 300 is arranged inside the transmission cavity 120 and is positioned between the drive unit 400 and the execution unit 200, and the transmission unit 300 partially extends into the execution cavity 110 and connects to the execution unit 200. The drive unit 400 is installed, as a power source, in the drive cavity 130, where an output end of the drive unit 400 extends into the transmission cavity 120 and connects to the transmission unit 300. The drive unit 400 drives, by means of the transmission unit 300, the execution unit 200 to move in the execution cavity 110, such that the liquid is pumped into the execution cavity 110 through the liquid inlet 111, and water flow impact is provided through the liquid outlet 112.

In practical applications, the fluid pumping assembly 1000 may be a diaphragm pump or a piston pump, and the drive unit 400 may be a cylinder or a motor. However, considering high controllability of the motor and simple and easy implementation of an electronic control structure, preferably the drive unit 400 in the present disclosure is the motor. The execution unit 200 may adopt different structures according to a specific form of the fluid pumping assembly 1000. For example, when the fluid pumping assembly 1000 is the diaphragm pump, the execution unit 200 may be a diaphragm structure; and when the fluid pumping assembly 1000 is the piston pump, the execution unit 200 may be a piston structure.

It is worth mentioning that a way for a most common damp fluid (a liquid or water vapor) to leak out of the fluid pumping assembly 1000 is as below. When the execution unit 200 moves in the execution cavity 110, the liquid may adhere to an inner wall surface (or an inner wall surface of a cylinder liner 210 positioned inside the execution cavity 110) of the execution cavity 110, and evaporate into the water vapor, which diffuses into the transmission cavity 120, causing leakage of the damp fluid. That is, the transmission cavity is a first area through which the most common damp fluid leaks. Therefore, in the present disclosure, the housing component 100 surrounds to form the transmission cavity 120, and the transmission cavity 120 is isolated and sealed from the exterior of the housing component 100, such that the sealed transmission cavity 120 may be used to confine the leaked damp fluid within the transmission cavity 120, thereby preventing the damp fluid from further diffusing to other areas and causing damage. Especially when the fluid pumping assembly 1000 is used in an oral cleaning device, it is avoidable causing damage to the electronic component inside the oral care device by the leakage of the damp fluid, thereby prolonging the service life of the oral care device.

Moreover, because the sealed transmission cavity 120 is formed by the housing component 100, in one aspect, the housing component 100 has higher hardness and thus is not easy to be damaged; and in another aspect, the housing component 100 does not need to follow the movement of the transmission unit 300, so the housing component 100 is less prone to fatigue damage, thereby ensuring sealing reliability and sealing life of the transmission cavity 120.

In addition, in the present disclosure, the housing component 100 is further utilized to form a drive cavity 130 for accommodating the drive unit 400, and the drive cavity 130 is isolated and sealed from the transmission cavity 120. In this way, the damp fluid leaked into the transmission cavity 120 may be prevented from further diffusing into the drive cavity 130 and causing damage to the drive unit 400, thereby ensuring the service life of the drive unit 400.

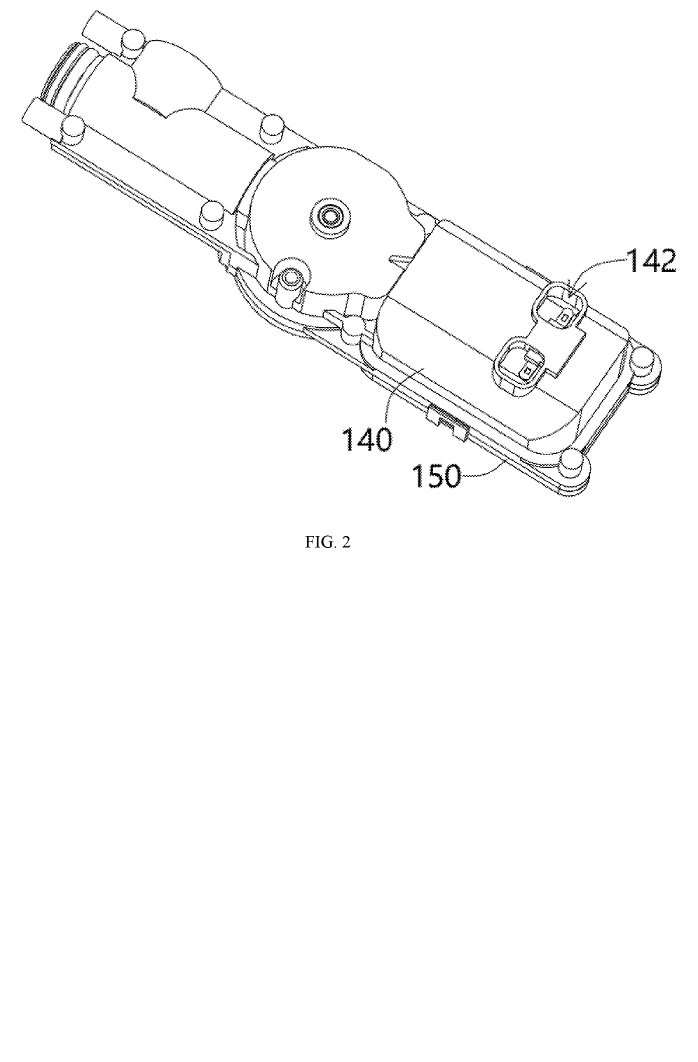

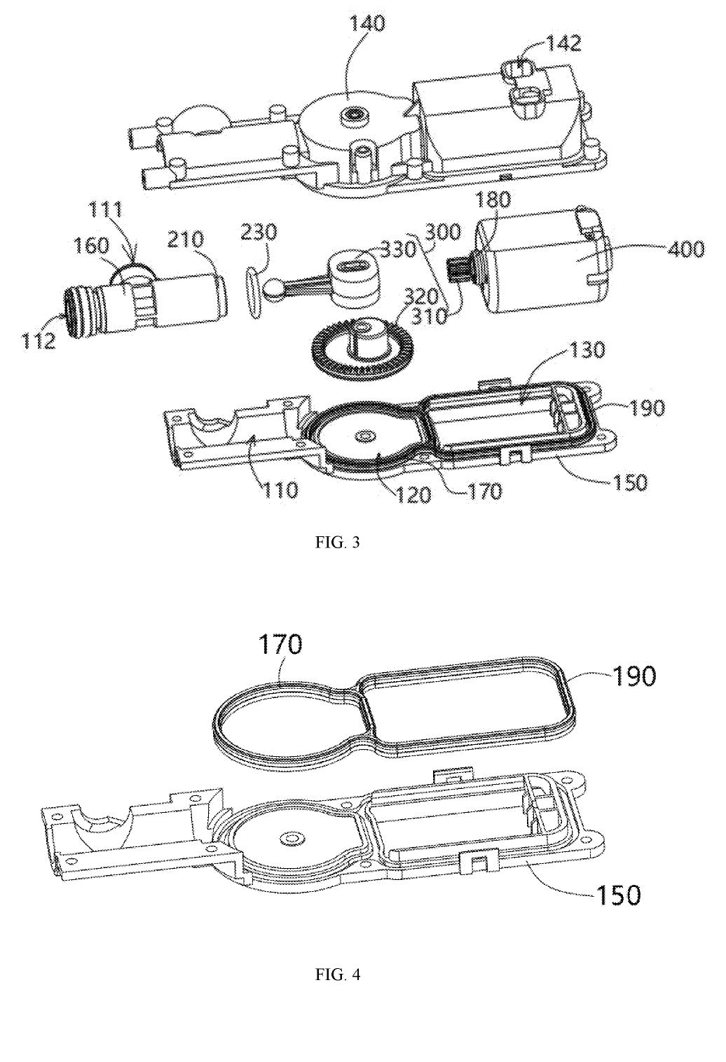

As shown in FIGS. 2 and 3, in an alternative embodiment, the housing component 100 may include a first housing piece 140, a second housing piece 150, and a pump body 160. The first housing piece 140 and the second housing piece 150 are coupled to each other, and jointly surround to form the execution cavity 110, the transmission cavity 120, and the drive cavity 130. The pump body 160 is connected to one end of an entirety formed by splicing the first housing piece 140 and the second housing piece 150.

In this embodiment, the pump body 160 may be made of metal such as copper or alloys, or may be made of other high-strength materials. The first housing piece 140 and the second housing piece 150 may be injection molded from injection molding parts.

In practical applications, a buckle structure may be provided around the first housing piece 140 and the second housing piece 150, where the first housing piece 140 and the second housing piece 150 are engaged with each other through the buckle structure and are spliced to form an entirety; and/or, the first housing piece 140 and the second housing piece 150 may be fastened by means of screws and are spliced to form an entirety. A sealing structure may be provided between the entirety formed by splicing the first housing piece 140 and the second housing piece 150 and the pump body 160, to seal an assembly gap between the entirety formed by splicing the first housing piece 140 and the second housing piece 150 and the pump body 160 through the sealing structure, and to prevent the damp fluid in the transmission cavity 120 from leaking to the exterior of the housing component 100 through the assembly gap.

Regarding to the specific sealing structure of the transmission cavity 120, as shown in FIGS. 3 to 6, in an implementable embodiment, a first sealing member 170 is provided on an engagement surface of the first housing piece 140 and/or the second housing piece 150, where the first sealing member 170 is arranged at least around the transmission cavity 120. In this way, the damp fluid inside the transmission cavity 120 is prevented from leaking to the exterior of the housing component 100 through a splicing gap between the first housing piece 140 and the second housing piece 150.

The first housing piece 140 or the second housing piece 150 is provided with a first clearance hole 141, where an output end of the drive unit 400 extends into the transmission cavity 120 through the first clearance hole 141. A second sealing member 180 is filled between the output end of the drive unit 400 and the first clearance hole 141.In this way, the damp fluid inside the transmission cavity 120 is prevented from leaking to the drive cavity 130 through a gap between the output end of the drive unit 400 and the first clearance hole 141, and from leaking to the exterior of the housing component 100 through the drive cavity 130.

The drive cavity 130 may communicate with the exterior of the housing component 100.

The drive cavity 130 may be isolated and sealed from the exterior of the housing component 100. As shown in FIGS. 3 and 4, in an implementable embodiment, a third sealing member 190 is provided on the engagement surface of the first housing piece 140 and/or the second housing piece 150, and the third sealing member 190 is arranged around the drive cavity 130. In this way, the damp fluid leaking to the drive cavity 130 is prevented from leaking to the exterior of the housing component 100 through the splicing gap between the first housing piece 140 and the second housing piece 150. Furthermore, considering that the drive unit 400 also requires wiring harness connection of electronic devices outside the housing component 100, the first housing piece 140 or the second housing piece 150 is provided with a wire harness connection hole 142 communicating with the drive cavity 130, and the wire harness connection hole 142 is filled with a sealant. In this way, the damp fluid leaking to the drive cavity 130 is prevented from leaking to the exterior of the housing component 100 through the wire harness connection hole 142. In this way, even if the damp fluid in the transmission cavity 120 accidentally leaks into the drive cavity 130, the sealing structure of the drive cavity 130 can confine the damp fluid within the housing component 100 and prevent hazards caused by the damp fluid from further diffusing to the exterior of the housing component 100, thereby narrowing range of the hazards caused by the damp fluid.

The first sealing member 170 and the third sealing member 190 may be integrally formed. That is, the first sealing member 170 and the third sealing member 190 may form an integral piece, making it easy to install and disassemble as a whole and simplifying the installation operation. Of course, the first sealing member 170 and the third sealing member 190 may also be independently arranged or at least partially overlapped with each other, but the present disclosure is not limited thereto.

In practical applications, the first housing piece 140 or the second housing piece 150 may be integrally formed with the first sealing member 170 by means of overmolding to simplify the assembly process. Of course, the engagement surface of the first housing piece 140 and/or the second housing piece 150 may be provided with an accommodation groove, such that the first sealing member 170 may be first installed in the accommodation groove, and then the first housing piece 140 is connected to the second housing piece 150.

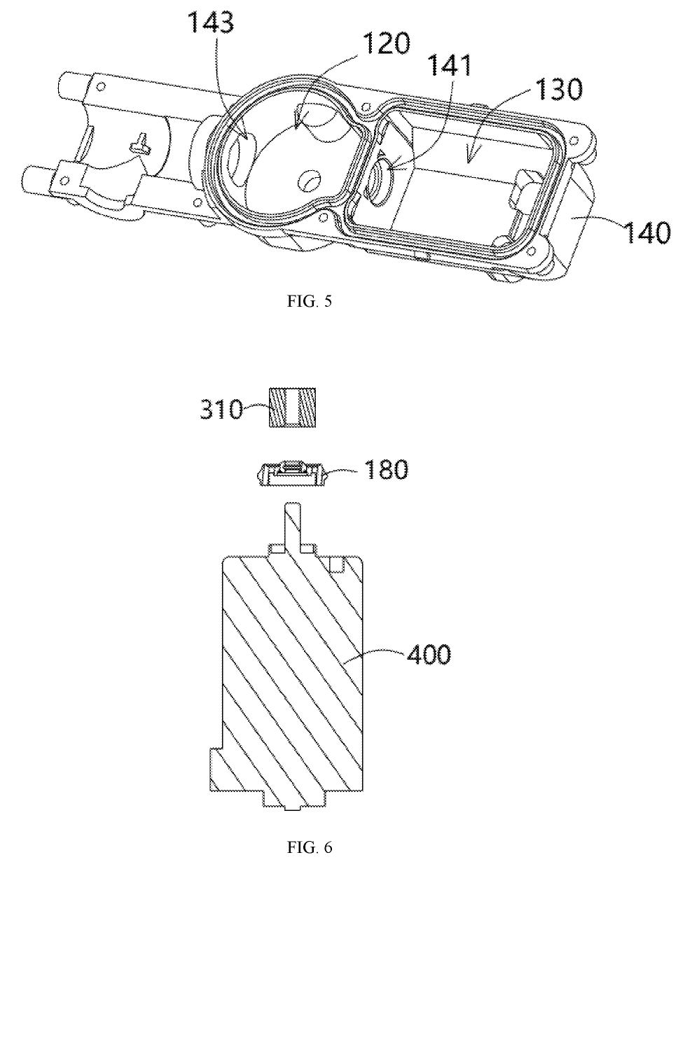

As shown in FIG. 5, in an implementable embodiment, the first clearance hole 141 and the wire harness connection hole 142 may be provided on the same housing piece. That is, both the first clearance hole 141 and the wire harness connection hole 142 are provided on the first housing piece 140, or both the first clearance hole 141 and the wire harness connection hole 142 are provided on the second housing piece 150, to facilitate the centralized opening design on one housing piece and simplify the structure of the other housing piece.

For ease of understanding of a specific assembly relationship between the execution unit 200 and the other structures inside the fluid pumping assembly 1000, an exemplary description will be provided below using the piston structure as the execution unit 200.

Referring again to FIGS. 1 and 3, in an implementable embodiment, the execution unit 200 may include a cylinder liner 210, a piston 220, and a fourth sealing member 230. The first housing piece 140 or the second housing piece 150 is provided with a second clearance hole 143, where the second clearance hole 143 communicates with the execution cavity 110 and the transmission cavity 120, and the cylinder liner 210 is inserted into the execution cavity 110. The piston 220 is slidably arranged inside the cylinder liner 210, and the piston 220 is connected to a piston sealing member 221, and a fitted seal is formed between the piston sealing member 221 and an inner wall surface of the cylinder liner 210. The fourth sealing member 230 is sleeved onto an outer wall surface at one end of the cylinder liner 210, and a fitted seal is formed between the fourth sealing member 230 and an inner wall surface of the second clearance hole 143. In this way, the piston sealing member 221 may be used to prevent the damp fluid inside the pump body 160 from leaking into the transmission cavity 120 through the interior of the cylinder liner 210, and the fourth sealing member 230 may be used to prevent the damp fluid inside the pump body 160 from leaking into the transmission cavity 120 through the exterior of the cylinder liner 210, thereby minimizing possibility of the damp fluid inside the pump body 160 leaking into the transmission cavity 120.

In practical applications, the piston sealing member 221 is used to prevent the damp fluid from leaking from the pump body 160 into the transmission cavity 120, and in addition, the piston sealing member 221 may also prevent leakage of pressure inside the pump body 160 and maintain internal pressure of the pump body 160. During multiple reciprocating movements of the piston 220, the pressure may be employed to pump the fluid into or out of the pump body 160. The piston sealing member 221 may be arranged at one end of the piston 220 away from the transmission unit 300, or the piston sealing member 221 may also be arranged on an outer circumferential surface of the piston 220. The fourth sealing member 230 may be an O-ring, to fit in shape to the outer wall surface of the cylinder liner 210 and the inner wall surface enclosed and formed by the first housing piece 140 and the second housing piece 150, thereby ensuring the sealing effect.

Regarding to the specific structure of transmission unit 300, as shown in FIG. 3, in an implementable embodiment, the transmission unit 300 may include a first gear 310, an end face eccentric gear 320, and a connecting rod 330. The first gear 310 and the end face eccentric gear 320 are both arranged inside the transmission cavity 120, the end face eccentric gear 320 is rotatably connected to the housing component 100, and the first gear 310 is connected to the output end of the drive unit 400 and is meshed with a gear portion of the end face eccentric gear 320. An eccentric portion of the end face eccentric gear 320 is connected to one end of the connecting rod 330, and the other end of the connecting rod 330 is connected to the execution unit 200. When the execution unit 200 is the piston structure, the other end of the connecting rod 330 is connected to the piston 220. When the drive unit 400 drives the first gear 310 to rotate, the first gear 310 may drive the eccentric portion of the end face eccentric gear 320 to perform an eccentric motion, and convert the eccentric motion into a linear motion by means of the connecting rod 330, thereby driving the execution unit 200 to perform a linear reciprocating motion.

The eccentric portion of the end face eccentric gear 320, the connecting rod 330 and the first gear 310 may be positioned on two opposite sides of the gear portion of the end face eccentric gear 320, respectively.

The first gear 310, the eccentric portion of the end face eccentric gear 320, and the connecting rod 330 may also be positioned on the same side of the gear portion of the end face eccentric gear 320. That is, the first gear 310, the eccentric portion of the end face eccentric gear 320, and the connecting rod 330 share the same thickness space. In this way, an overall thickness of the fluid pumping assembly 1000 may be reduced, thereby thinning the fluid pumping assembly 1000. When the fluid pumping assembly 1000 is used in a grip housing of the oral care device, by thinning the fluid pumping assembly 1000, the grip housing may be made as thin as possible, making it convenient for a user to grip.

As shown in FIG. 1, in an implementable embodiment, the output end of the drive unit 400 has an axis line of the output end. The drive unit 400, the transmission unit 300, and the execution unit 200 may be arranged along the axis line of the output end of the drive unit 400. That is, the drive unit 400, the transmission unit 300, and the execution unit 200 are arranged in a straight line, thereby further thinning the grip housing.

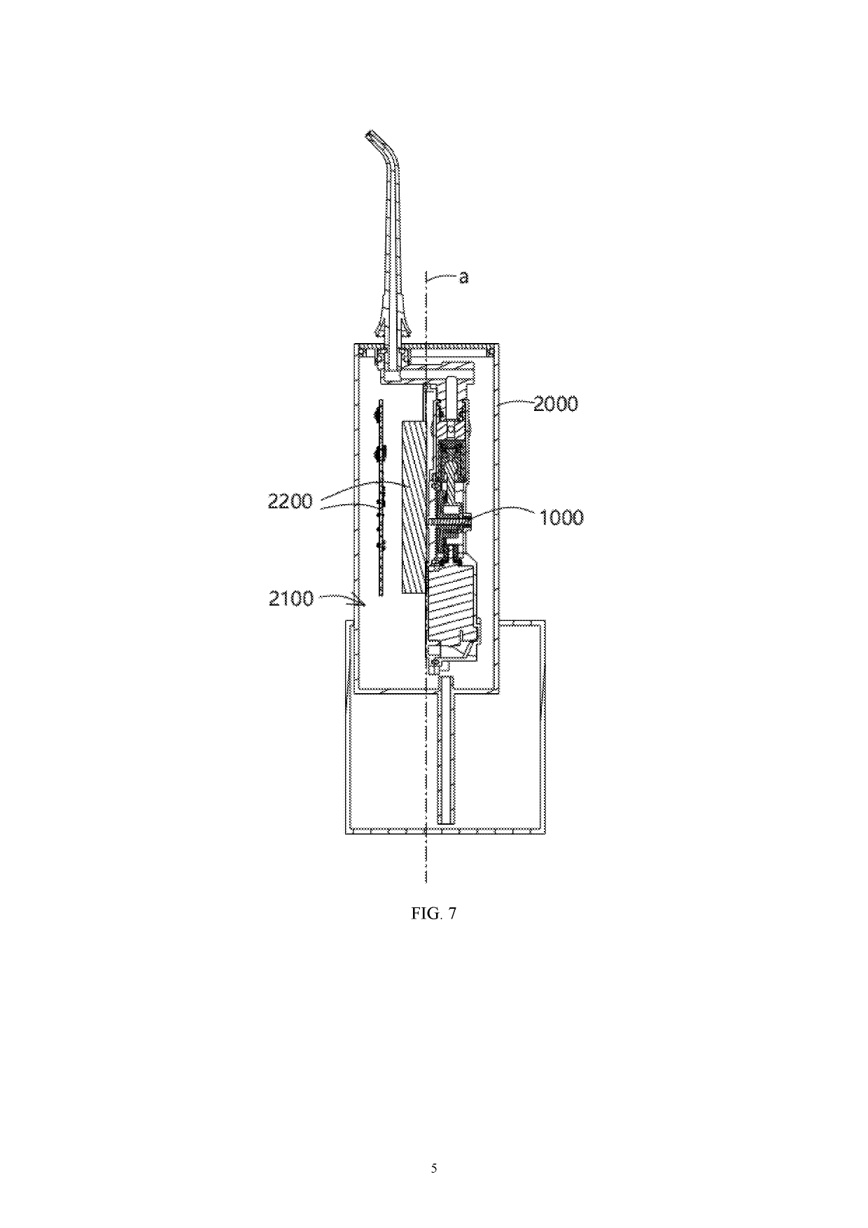

Based on the same inventive concept, as shown in FIG. 7, the present disclosure also provides an oral care device, which may be an oral irrigator or an integrated flushing machine, etc. Specifically, the oral care device at least includes a grip housing 2000 and the aforementioned fluid pumping assembly 1000, where the grip housing 2000 has an outer wall and an accommodation chamber 2100 enclosed by the outer wall, and the accommodation chamber 2100 is configured to accommodate an electronic device 2200 and the fluid pumping assembly 1000.

Taking an example where the oral care device is the integrated flushing machine, the oral care device may also include a brush head and a motor. The brush head has a transfer channel and a communication port and a liquid spray port positioned at two ends of the transfer channel. The brush head may be provided with bristles, which are positioned at one end of the brush head provided with the liquid spray port. The motor has a power output shaft, and the motor is connected to the brush head through the power output shaft to drive the brush head to perform a cleaning motion. Moreover, the power output shaft is a hollow shaft, and the liquid outlet 112 of the fluid pumping assembly 1000 communicates with the transfer channel inside the brush head by means of the power output shaft, such that the fluid pumped by the fluid pumping assembly 1000 may pass through the power output shaft and the transfer channel in sequence, and finally output the water flow impact from the liquid spray port.

Taking an example where the oral care device is the oral irrigator, the oral care device also includes a nozzle head connected to the grip housing 2000, and the nozzle head communicates with the liquid outlet 112 of the fluid pumping assembly 1000, such that the fluid pumped by the fluid pumping assembly 1000 outputs the water flow impact through the nozzle head.

Further, the grip housing 2000 has a main extension line a. The axis line of the output end of the drive unit 400 is roughly parallel to the main extension line a, and the electronic device 2200 and the fluid pumping assembly 1000 are arranged along a direction perpendicular to the main extension line a. By arranging the drive unit 400, the transmission unit 300, and the execution unit 200 along the main extension line a, the fluid pumping assembly 1000 is thinned, such that there is a reserved space in the accommodation chamber 2100 along the direction perpendicular to the main extension line a, to accommodate the electronic device 2200.

In an implementable embodiment, the housing component 100 may be provided with a communication hole that communicates with the transmission cavity 120, and the communication hole communicates with external environment through a draft tube. In this way, when the damp fluid in the execution cavity 110 leaks into the transmission cavity 120, the damp fluid may flow to the external environment through the draft tube, thereby preventing long-term retention of the damp fluid in the transmission cavity 120 from causing damage to components in the transmission cavity 120 and the sealing structure of the transmission cavity 120, and thus reducing the possibility of causing damage to the drive unit 400 and the electronic device 2200.

In practical applications, the communication hole may be provided on the first housing piece 140 or the second housing piece 150, and is positioned at the bottom of the transmission cavity 120, to make it easier for the damp fluid leaked into the transmission cavity 120 to flow out.

It should be pointed out that the main extension line a may be understood as a line connecting midpoints of cross-sections of the grip housing 2000. Reference may be made to the detailed description recorded in the above embodiments for the specific structure of the fluid pumping assembly 1000, which is not to be described in detail herein.

The terms such as "upper” and "lower” for describing relative positional relationships of various structures in the drawings are merely for the purpose of concise description rather than limiting the implementable scope of the present disclosure. The changes or adjustments of the relative relationship without a substantial modification to the technical solutions are regarded as being covered by the implementable scope of the present disclosure.

It is to be noted that in the present disclosure, unless specified or limited otherwise, a first feature “on” or “below” a second feature may include an embodiment in which the first feature is in direct contact with the second feature, and may also include an embodiment in which the first feature and the second feature are in indirect contact via an intermediary. Furthermore, a first feature “on,” “above,” or “on top of” a second feature may include an embodiment in which the first feature is right or obliquely “on,” “above,” or “on top of” the second feature, or just means that the first feature is at a height higher than that of the second feature. A first feature “below,” “under,” or “on bottom of” a second feature may include an embodiment in which the first feature is right or obliquely “below,” “under,” or “on bottom of” the second feature, or just means that the first feature is at a height lower than that of the second feature.

In addition, in the present disclosure, unless specified or limited otherwise, terms “mounted”, “connected”, “coupled”, “fixed” and so on should be understood in a broad sense, which may be, for example, a fixed connection, a detachable connection or integrated connection, a direct connection or indirect connection by means of an intermediary, an internal communication between two elements or an interaction relationship between two elements. The specific significations of the above terms in the present disclosure may be understood in the light of specific conditions by persons of ordinary skill in the art.

Reference throughout this specification to the terms “an embodiment,” “some embodiments,” “an exemplary embodiment,” “an example,” “a specific example,” or “some examples,” means that a specific feature, structure, material, or characteristic described in connection with the embodiment or example is included in at least one embodiment or example of the present disclosure. The schematic representation of the above terms throughout this specification are not necessarily referring to the same embodiment or example. Furthermore, the specific features, structures, materials, or characteristics set forth may be combined in any suitable manner in one or more embodiments or examples.

Finally, it is to be noted that the foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, which does not make corresponding technical solutions in essence depart from the scope of the technical solutions of the embodiments of the present disclosure.

What is claimed is:

1. A fluid pumping assembly for oral cleaning, wherein the fluid pumping assembly (1000) at least comprises:
a housing component (100) having an execution cavity (110), a transmission cavity (120), a drive cavity (130), and a liquid inlet (111) and a liquid outlet (112) communicating with the execution cavity (110), the transmission cavity (120) being isolated and sealed from an exterior of the housing component (100), and the transmission cavity (120) being isolated and sealed from the drive cavity (130);
an execution unit (200) arranged inside the execution cavity (110);
a transmission unit (300) arranged inside the transmission cavity (120), part of the transmission unit (300) extending into the execution cavity (110) and being connected to the execution unit (200); and
a drive unit (400) arranged inside the drive cavity (130), an output end of the drive unit (400) extending into the transmission cavity (120) and being connected to the transmission unit (300), the drive unit (400) being configured to drive, by means of the transmission unit (300), the execution unit (200) to move in the execution cavity (110), to pump a liquid into the execution cavity (110) through the liquid inlet (111) and provide water flow impact through the liquid outlet (112).

2. The fluid pumping assembly according to claim 1, wherein the housing component (100) comprises a first housing piece (140), a second housing piece (150), and a pump body (160);
wherein the first housing piece (140) and the second housing piece (150) are coupled to each other, and jointly surround to form the execution cavity (110), the transmission cavity (120), and the drive cavity (130); and
wherein the pump body (160) is connected to one end of an entirety formed by splicing the first housing piece (140) and the second housing piece (150).

3. The fluid pumping assembly according to claim 2, wherein a first sealing member (170) is provided on an engagement surface of the first housing piece (140) and/or the second housing piece (150), and the first sealing member (170) is arranged at least around the transmission cavity (120); and/or
the first housing piece (140) or the second housing piece (150) is provided with a first clearance hole (141), an output end of the drive unit (400) extends into the transmission cavity (120) through the first clearance hole (141), and a second sealing member (180) is filled between the output end of the drive unit (400) and the first clearance hole (141).

4. The fluid pumping assembly according to claim 3, wherein a third sealing member (190) is provided on the engagement surface of the first housing piece (140) and/or the second housing piece (150), and the third sealing member (190) is arranged around the drive cavity (130).

5. The fluid pumping assembly according to claim 4, wherein the first sealing member (170) and the third sealing member (190) are integrally formed.

6. The fluid pumping assembly according to claim 4, wherein the first sealing member (170) and the third sealing member (190) are independently arranged or at least partially overlapped with each other.

7. The fluid pumping assembly according to claim 3, wherein one of the first housing piece (140) and the second housing piece (150) is integrally formed with the first sealing member (170) by means of overmolding, and the other one of the first housing piece (140) and the second housing piece (150) is in an interference fit with the first sealing member (170).

8. The fluid pumping assembly according to claim 4, wherein one of the first housing piece (140) and the second housing piece (150) is integrally formed with the first sealing member (170) and/or the third sealing member by means of overmolding, and the other one of the first housing piece (140) and the second housing piece (150) is in an interference fit with the first sealing member (170) and/or the third sealing member.

9. The fluid pumping assembly according to claim 3, wherein the first housing piece (140) or the second housing piece (150) is provided with a wire harness connection hole (142) communicating with the drive cavity (130), and the wire harness connection hole (142) is filled with a sealant.

10. The fluid pumping assembly according to claim 9, wherein the first clearance hole (141) and the wire harness connection hole (142) are both provided on the first housing piece (140).

11. The fluid pumping assembly according to claim 2, wherein the execution unit (200) comprises a cylinder liner (210), a piston (220), and a fourth sealing member (230);
the first housing piece (140) or the second housing piece (150) is provided with a second clearance hole (143), the second clearance hole (143) communicates with the execution cavity (110) and the transmission cavity (120), and the cylinder liner (210) is inserted into the execution cavity (110);
the piston (220) is slidably arranged inside the cylinder liner (210), the piston (220) is connected to a piston sealing member (221), and a fitted seal is formed between the piston sealing member (221) and an inner wall surface of the cylinder liner (210); and
the fourth sealing member (230) is sleeved onto an outer wall surface at one end of the cylinder liner (210), and a fitted seal is formed between the fourth sealing member (230) and an inner wall surface of the second clearance hole (143).

12. The fluid pumping assembly according to claim 1, wherein the transmission unit (300) comprises a first gear (310), an end face eccentric gear (320), and a connecting rod (330);
the first gear (310) and the end face eccentric gear (320) are arranged inside the transmission cavity (120), and the first gear (310) is connected to the output end of the drive unit (400) and is meshed with a gear portion of the end face eccentric gear (320); and
an eccentric portion of the end face eccentric gear (320) is connected to one end of the connecting rod (330), and the other end of the connecting rod (330) is connected to the execution unit (200), and the first gear (310), the eccentric portion of the end face eccentric gear (320), and the connecting rod (330) are positioned on a same side of the gear portion of the end face eccentric gear (320).

13. The fluid pumping assembly according to claim 1, wherein the drive unit (400), the transmission unit (300), and the execution unit (200) are arranged along an axis line of the output end of the drive unit (400).

14. An oral care device at least comprising a grip housing (2000) and the fluid pumping assembly (1000) according to claim 1, wherein the grip housing (2000) has an outer wall and an accommodation chamber (2100) enclosed by the outer wall, and the accommodation chamber (2100) is configured to accommodate an electronic device (2200) and the fluid pumping assembly (1000).

15. The oral care device according to claim 14 further comprising a brush head and a motor; wherein
the motor has a power output shaft, the motor drives the brush head to perform a cleaning motion by means of the power output shaft, the power output shaft is a hollow shaft, and the liquid outlet (112) communicates with a transfer channel inside the brush head by means of the power output shaft.

16. The oral care device according to claim 14, wherein the grip housing (2000) has a main extension line (a); and
an axis line of the output end of the drive unit (400) is roughly parallel to the main extension line (a), and the electronic device (2200) and the fluid pumping assembly (1000) are arranged along a direction perpendicular to the main extension line (a).
